(19) United States
(12) Patent Application Publication
(10) Pub. No.: US 2026/0119787 A1
(43) Pub. Date: Apr. 30, 2026

(54) AUTOMATIC FORM COMPLETION AND RENEWAL

(71) Applicant: GovPlus LLC, San Juan, PR (US)

(72) Inventor: Guy LELOUCH, San Juan, PR (US)

(21) Appl. No.: 19/373,289

(22) Filed: Oct. 29, 2025

Related U.S. Application Data
(60) Provisional application No. 63/713,999, filed on Oct. 30, 2024.

(51) Int. Cl. G06F 40/174; G06F 9/451; G06F 16/34; G06V 40/30; H04L 9/08; H04L 67/306

(52) U.S. Cl. CPC G06F 40/174; G06F 9/451; G06F 16/345; G06V 40/33; H04L 9/0825; H04L 67/306

(57) ABSTRACT

Methods, storage media and systems for managing forms and documents are disclosed. Some embodiments may include storing data filled by a user into a first form to encrypted cloud storage, autofilling a second form having at least one field matching a field from the first form with the data requested from the encrypted cloud storage in the at least one matching field for two or more people from the same household, auto-renewing expiring documents, and providing replacement documents.

This application claims the benefit of priority of U.S. Provisional Application No. 63/713,999, filed Oct. 30, 2024, the contents of which are incorporated by reference as if written herein in their entirety.

### FIELD OF THE DISCLOSURE

The present disclosure relates to methods, storage media, and systems for automatically completing forms for two or more members within a household, automatically renewing forms, and providing replacement documents.

### BACKGROUND

Nowadays, many prefer to stay at home and manage their bookkeeping and document processing online. However, once they start applying for a service, like changing addresses, updating their Social Security accounts, asking for Employee Identification Numbers, or applying for a birth certificate for their newborn, they are faced with many forms and fields to fill. Sometimes, the same data must be filled in repeatedly for two or more people from the same household, taking extra effort and time. Filing the same information repeatedly also increases mistakes and the risk of not filling out the form correctly per government standards, costing even more time and frustration. Keeping track of expiration dates for each document and applying for renewal provides an additional layer of diligence. Further, the ability to quickly and easily apply for replacement documents lessens the burden on the user.

### SUMMARY

The following embodiments and aspects are described and illustrated in conjunction with methods, media, and systems, which are meant to be exemplary and illustrative, not limiting in scope. In various embodiments, one or more of the above-described problems have been reduced or eliminated, while other embodiments are directed to other improvements.

The computerized method may include storing data filled by a user into a first form to encrypted cloud storage. The method may include autofilling a second form with at least one field matching a field from the first form with the data requested from the encrypted cloud storage in at least one matching field. The method may include filling in by the user non-matching fields with new data. The method may include storing the new data in encrypted cloud storage.

The present disclosure also provides a non-transient computer-readable storage medium for automatically completing forms. In some embodiments, the computer-readable storage medium may include instructions being executable by one or more processors to store data filled by a user into a first form to encrypted cloud storage. In some embodiments, the computer-readable storage medium may include instructions being executable by one or more processors to autofill a second form having at least one field that matches a field from the first form with the data requested from the encrypted cloud storage in the at least one matching field. In some embodiments, the computer-readable storage medium may include instructions being executable by one or more processors to fill in by the user non-matching fields with new data. In some embodiments, the computer-readable storage medium may include instructions being executable by one or more processors to store the new data to the encrypted cloud storage.

The present disclosure further provides a system for automatically completing forms. The system may include one or more hardware processors configured by machine-readable instructions for automatically completing forms. The machine-readable instructions may be configured to store data filled by a user into a first form to encrypted cloud storage. The machine-readable instructions may be configured to autofill a second form having at least one field that matches a field from the first form with the data requested from the encrypted cloud storage in the at least one matching field. The machine-readable instructions may be configured to fill in by the user non-matching fields with new data. The machine-readable instructions may be configured to store the new data to the encrypted cloud storage.

Additional embodiments and features are set forth in part in the description that follows. In part will become apparent to those skilled in the art upon examination of the specification or learned by the practice of the embodiments discussed herein. A further understanding of the nature and advantages of certain embodiments may be realized by reference to the remaining portions of the specification and the drawings, which form a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 illustrates a system configured for automatically completing a form from two or more members of the same household.

FIG. 2 illustrates a method for using the family dashboard to for automatically completing a form from two or more members of the same household. The user can optionally activate document protection and/or auto-renewal upon completion.

FIG. 3 illustrates another system configured for automatically completing a form from two or more members of the same household.

FIG. 4 illustrates another method for automatically completing a form from two or more members of the same household.

FIG. 5 shows the login dashboard with the option to select family members highlighted, but no family dashboard subscription and no family members yet added.

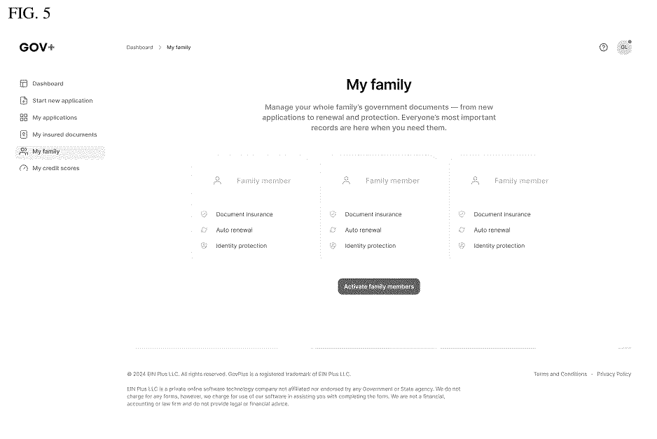

FIG. 6 shows the login dashboard with the option to select family members highlighted and the family dashboard subscription activated, but no family members yet added.

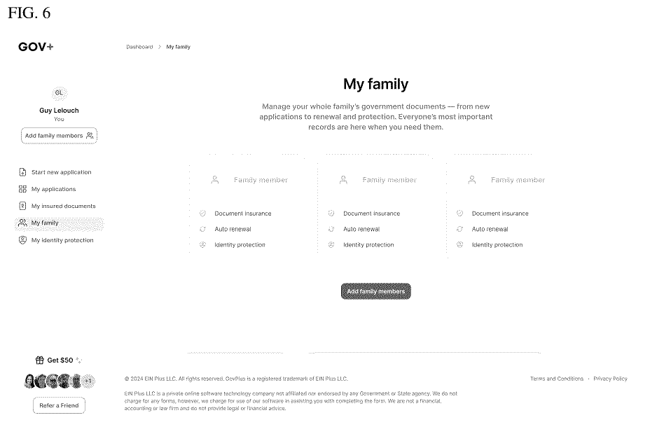

FIG. 7 shows a family member profile in an activated family dashboard subscription overlay to add information after “add family member” has been selected.

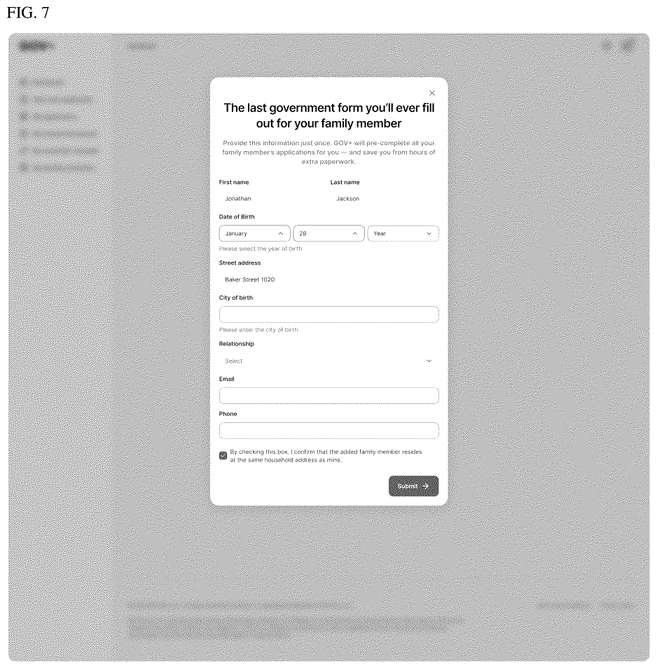

FIG. 8 shows the login dashboard with the option to select family members highlighted and the family dashboard showing two family members added.

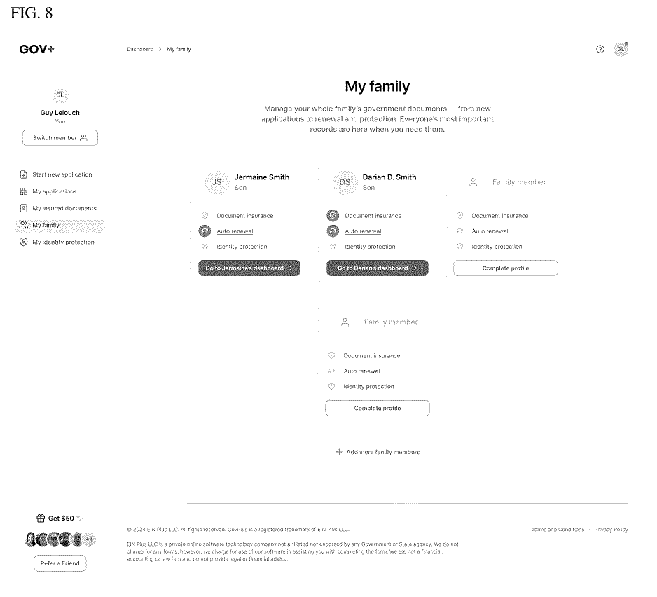

FIG. 9 shows the family dashboard providing one option wherein selection of a family member will open an option to start a new application.

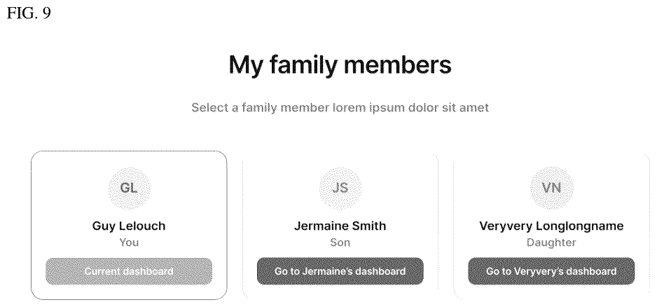

FIG. 10 shows the login dashboard with the leftmost family member selected, providing an option to select services showing and a drop-down menu to select service associated with the application from a pre-filled list of government applications.

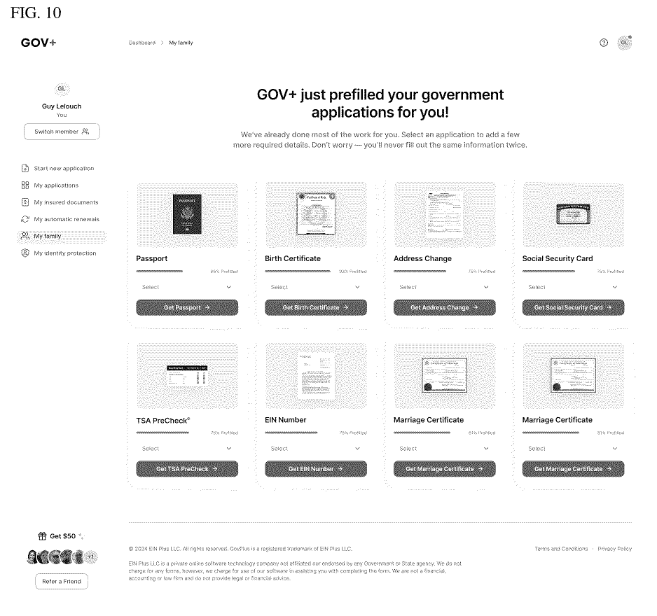

FIG. 11 shows the login dashboard after a family member has been selected, a service selected, and a “new application” selected, and an overlay to enter information pertinent to the selected service.

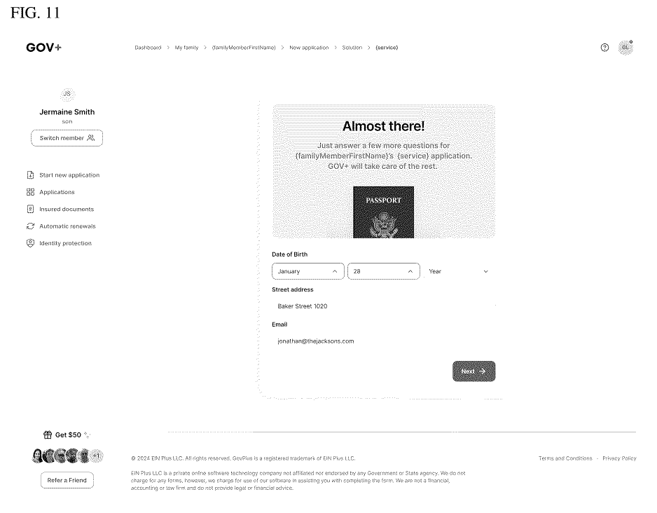

FIG. 12 shows the login dashboard after a family member has been selected, a service selected, and a “new application” selected, and an overlay offering processing options.

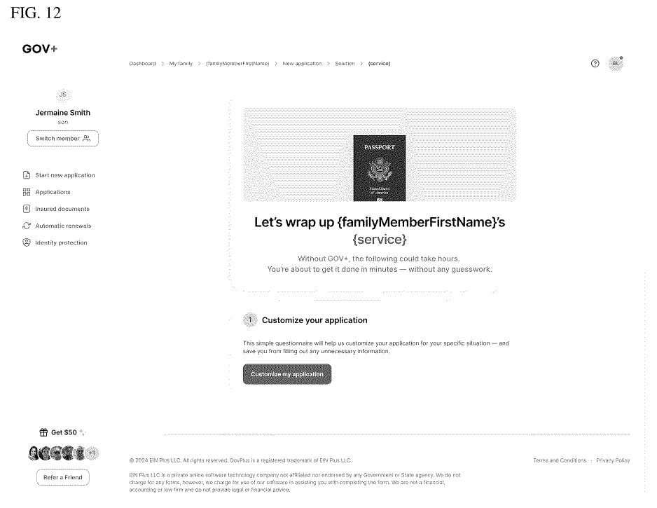

FIG. 13 shows the login dashboard with the option to select family members highlighted and the family dashboard showing several family members, and a cursor positioned to select deletion of the rightmost family member by clicking an “x” icon.

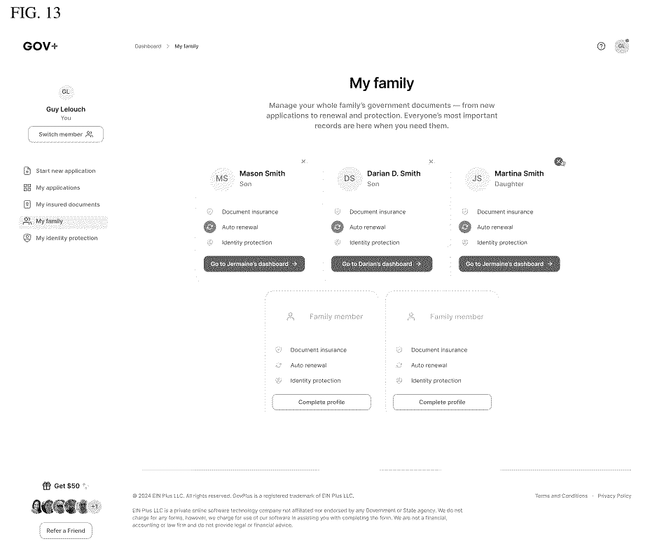

FIG. 14 shows, in an activated family dashboard subscription, an overlay offering confirmation of deletion of a family member.

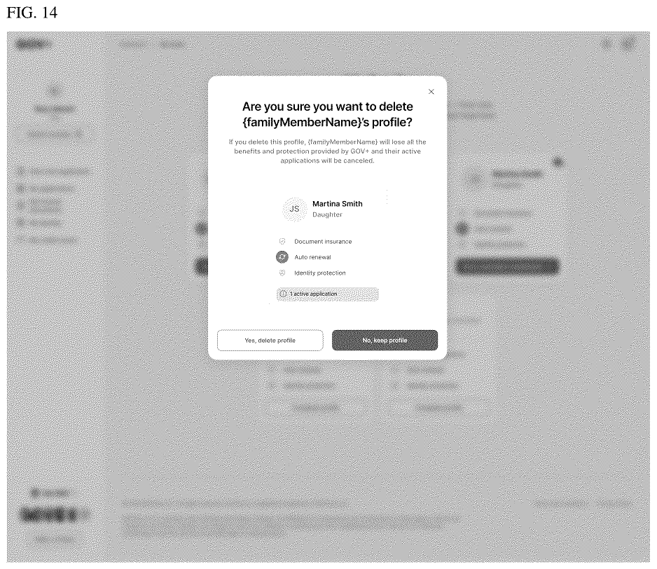

FIG. 15 shows the login dashboard with the option to activate automatic renewals highlighted.

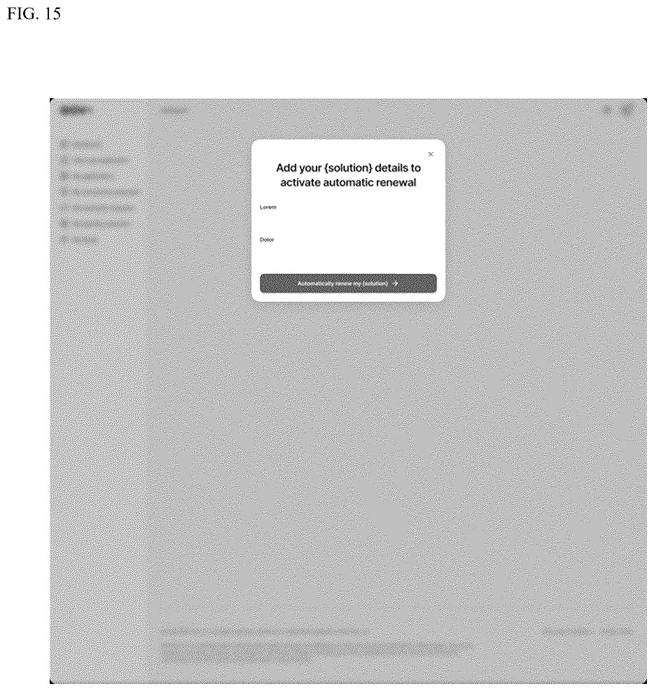

FIG. 16 shows the login dashboard with some previously submitted government documents available for autorenewal.

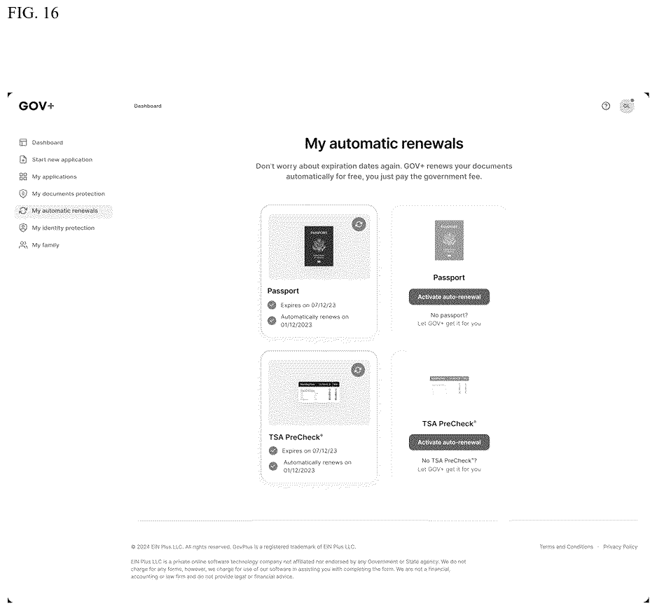

FIG. 17 shows, in an activated dashboard subscription, an overlay offering the option to add the user's passport to documents available for autorenewal.

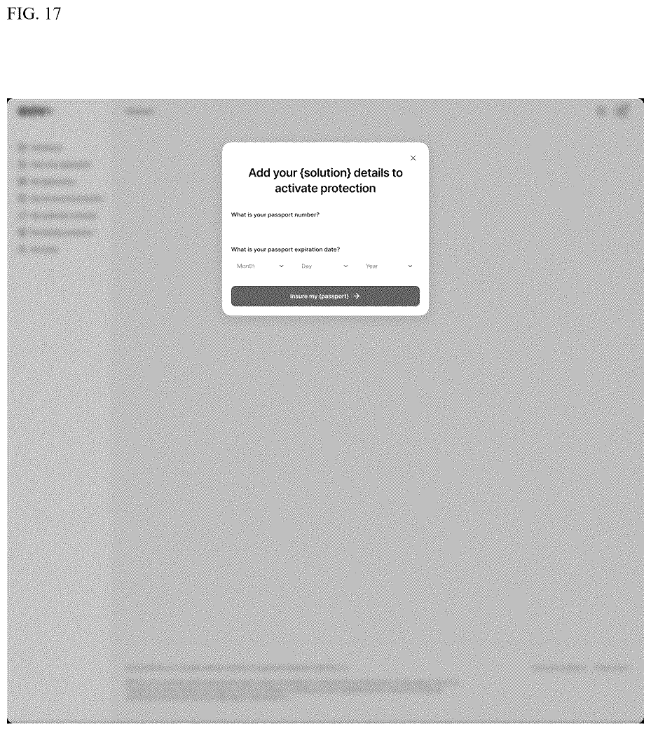

FIG. 18 shows the login dashboard with the option to protect government documents highlighted.

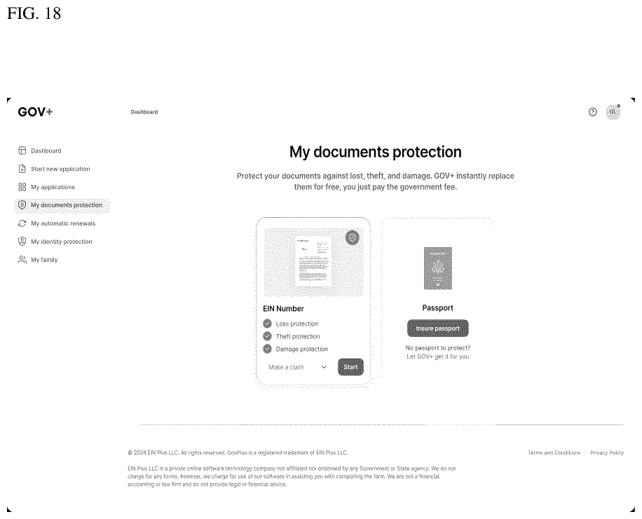

### DETAILED DESCRIPTION

Provided herein is a tailored solution that allows the customer to speed up the form-filling process significantly. Once a user logs in to their account and applies for the first form, the platform saves the data used in that form in an encrypted format stored on the dedicated secure web server. Once the user logs into their account and wants to complete another form, all the fields used in previous forms are pre-filled automatically. Additionally, two or more users from the same household can use the method to enter data at the same time. The platform also tracks the expiration dates for each document and allows the user to apply for renewal of the document. Additionally, the user is able to apply for replacement documents using the platform.

“New data” refers to a distinct category or field that is different from any category or field data that was previously captured. In certain embodiments, the categories or field data are detected based on machine-readable data.

As used herein, members of a household are people sharing one or more of a common address, surname, and emergency contact information.

In certain embodiments, the encryption algorithm for encrypted cloud storage is proprietary. In certain embodiments, data encryption is maintained throughout the method.

Also, all the new data, which was filled manually, are added to the existing storage. The more forms a user completes with the disclosed methods, media, and systems, the less time future forms take, simplifying the interactions. In the end, the form application process uses a series of clicks. The back-and-forth with the government is also avoided, as the form is filled out correctly each time due to no human intervention during data input.

In certain embodiments, the method further comprises logging, by the user, into a platform for a first form having fields.

In certain embodiments, the method further comprises sending the filled first form to the user.

In certain embodiments, further comprises providing to the user a set of computer-executed instructions that, when executed by a user's user device, generate a user interface displayable on an electronic display coupled to the user's user device.

Disclosed herein is a computerized method for managing and sharing user profile information within a family dashboard, the method comprising:
storing, in a database, user profile data for two or more members within a household to define a family dashboard;
establishing at least one overlapping field within the user profiles of the members;
automatically updating the at least one overlapping field within the user profiles of the other members of the household with data from any one of the user profiles;
retrieving the at least one updated overlapping field from the database when generating for a member a governmental application from a government agency; and
auto-populating the governmental application for the member with the at least one retrieved overlapping field.

In certain embodiments, encrypted data filled by a user into a first form is stored to encrypted cloud storage.

In certain embodiments, a second form having at least one field matching a field from the first form with the stored encrypted data from the encrypted cloud storage is autofilled in the at least one matching field.

In certain embodiments, at least one of the first form and the second form are governmental applications from different government agencies.

In certain embodiments, the user fills in any non-matching fields with new encrypted data; storing the new encrypted data to the encrypted cloud storage.

In certain embodiments, the method further comprises applying securely for missing birth certificate, passport, passport photo or missing documents that are not included in the storage.

In certain embodiments, the user or a user's signature is verified using a vital document, a third-party signature service, or an electronic token exchange.

In certain embodiments, the method further comprises logging, by the user, into a platform for the first form having fields.

In certain embodiments, the method further comprises sending the filled first form to the user.

In certain embodiments, the method further comprises providing to the user a set of computer-executed instructions that, when executed by a user's user device, generate a user interface displayable on an electronic display coupled to the user's user device.

In certain embodiments, the method further comprises verifying that the encrypted data and the new encrypted data are correct per a government standard with a computer-implemented verification process.

In certain embodiments, the verifying step uses a vital document.

In certain embodiments, the vital document is an image file or a certified electronic copy from an issuing government authority.

In certain embodiments, the vital document is chosen from a birth certificate, driver's license, travel visa or passport.

In certain embodiments, the vital document is saved in the encrypted cloud drive for the user to use later to verify the user's identity, to verify the user's signature, or to submit as supporting documentation for a government application.

In certain embodiments, the verifying step uses a third-party signature service.

In certain embodiments, the verifying step uses an electronic token exchange.

In certain embodiments, the electronic token exchange comprises a public or private key.

In certain embodiments, two or more second forms having at least one field matching a field from the first form are autofilled with the stored encrypted cloud storage in the at least one matching field of the two or more second forms.

In certain embodiments, the method further comprises displaying a completion status of further forms, which is automatically updated when the second form is completed.

In certain embodiments, the members within the household belong to a family.

In certain embodiments, the two or more members comprise one primary user and one or more secondary users.

In certain embodiments, the primary user modifies data in the fields for all members included in the dashboard.

In certain embodiments, the secondary users are chosen from spouse, child, parent, and sibling.

In certain embodiments, the method further comprises allowing the primary user to approve or modify the auto-populated governmental application for the one or more secondary users before submission.

In certain embodiments, the overlapping fields include information such as family name, home address, and emergency contact details.

In certain embodiments, the passport, birth certificate, passport photo, travel visa, and/or driver's license is available on the dashboard.

In certain embodiments, the method further comprises receiving, from a user via a user device, a completed governmental application for one member, the completed governmental application including data for the overlapping field.

In certain embodiments, the user profiles of the members are linked based on a familial relationship identifier.

In certain embodiments, the method further comprises submitting the auto-populated governmental application to a server of the government agency.

In certain embodiments, the family dashboard provides a summary view of all pending and completed governmental applications for the household members.

In certain embodiments, the method further comprises displaying personalized recommendations for additional governmental services based on application history.

In certain embodiments, the recommendations include renewal reminders for expiring documents, updates on new governmental programs, and suggestions for related services.

In certain embodiments, the method further comprises tracking and displaying status of each household member's governmental application in real-time on the family dashboard.

In certain embodiments, the method further comprises a secure messaging feature allowing household members to communicate with a customer support representative through the family dashboard.

In certain embodiments, the method further comprises an activity log that logs all actions taken on each household member's profile and governmental applications.

In certain embodiments, the family dashboard provides an option to schedule future governmental applications and set deadline reminders.

In certain embodiments, the family dashboard provides an option to delete family members.

In certain embodiments, the database is a post-release structured query language database.

Further disclosed herein is a computer system for managing and sharing user profile information within a family dashboard, the system comprising:
a database configured to store user profile data for two or more members within a household to define a family dashboard;
a processor configured to establish at least one overlapping field within the user profiles of the members;
a module configured to automatically update the at least one overlapping field within the user profiles of the other members of the household with data from any one of the user profiles;
a retrieval module configured to retrieve the at least one updated overlapping field from the database when generating for a member a governmental application from a government agency; and
an auto-population module configured to auto-populate the governmental application for the member with the at least one retrieved overlapping field.

In certain embodiments, the members within the household belong to a family.

In certain embodiments, the two or more members comprise one primary user and one or more secondary users.

In certain embodiments, the primary user modifies data in the fields for all members included in the dashboard.

In certain embodiments, the secondary users are chosen from spouse, child, parent, and sibling.

In certain embodiments, the method further comprises allowing the primary user to approve or modify the auto-populated governmental application for the one or more secondary users before submission.

In certain embodiments, the overlapping fields include information such as family name, home address, and emergency contact details.

In certain embodiments, the method further comprises receiving, from a user via a user device, a completed governmental application for one member, the completed governmental application including data for the overlapping field.

In certain embodiments, the user profiles of the members are linked based on a familial relationship identifier.

In certain embodiments, the method further comprises submitting the auto-populated governmental application to a server of the government agency.

In certain embodiments, the family dashboard provides a summary view of all pending and completed governmental applications for the household members.

In certain embodiments, the method further comprises displaying personalized recommendations for additional governmental services based on application history.

In certain embodiments, the recommendations include renewal reminders for expiring documents, updates on new governmental programs, and suggestions for related services.

In certain embodiments, the method further comprises tracking and displaying status of each household member's governmental application in real-time on the family dashboard.

In certain embodiments, the method further comprises a secure messaging feature allowing household members to communicate with a customer support representative through the family dashboard.

In certain embodiments, the method further comprises an activity log that logs all actions taken on each household member's profile and governmental applications.

In certain embodiments, the family dashboard provides an option to schedule future governmental applications and set deadline reminders.

In certain embodiments, the family dashboard provides an option to delete family members.

In certain embodiments, the database is a post-release structured query language database.

Further disclosed herein is a non-transitory computer-readable medium storing instructions that, when executed by one or more processors, cause a computer system to perform a method for managing and sharing user profile information within a family dashboard, the method comprising:
storing, in a database, user profile data for two or more members within a household to define a family dashboard;
establishing at least one overlapping field within the user profiles of the members;
automatically updating the at least one overlapping field within the user profiles of the other members of the household with data from any one of the user profiles;
retrieving the at least one updated overlapping field from the database when generating for a member a governmental application from a government agency; and
auto-populating the governmental application for the member with the at least one retrieved overlapping field.

In certain embodiments, the members within the household belong to a family.

In certain embodiments, the two or more members comprise one primary user and one or more secondary users.

In certain embodiments, the primary user modifies data in the fields for all members included in the dashboard.

In certain embodiments, the secondary users are chosen from spouse, child, parent, and sibling.

In certain embodiments, the method further comprises allowing the primary user to approve or modify the auto-populated governmental application for the one or more secondary users before submission.

In certain embodiments, the overlapping fields include information such as family name, home address, and emergency contact details.

In certain embodiments, the method further comprises receiving, from a user via a user device, a completed governmental application for one member, the completed governmental application including data for the overlapping field.

In certain embodiments, the user profiles of the members are linked based on a familial relationship identifier.

In certain embodiments, the method further comprises submitting the auto-populated governmental application to a server of the government agency.

In certain embodiments, the family dashboard provides a summary view of all pending and completed governmental applications for the household members.

In certain embodiments, the method further comprises displaying personalized recommendations for additional governmental services based on application history.

In certain embodiments, the recommendations include renewal reminders for expiring documents, updates on new governmental programs, and suggestions for related services.

In certain embodiments, the method further comprises tracking and displaying status of each household member's governmental application in real-time on the family dashboard.

In certain embodiments, the method further comprises a secure messaging feature allowing household members to communicate with a customer support representative through the family dashboard.

In certain embodiments, the method further comprises an activity log that logs all actions taken on each household member's profile and governmental applications.

In certain embodiments, the family dashboard provides an option to schedule future governmental applications and set deadline reminders.

In certain embodiments, the family dashboard provides an option to delete family members.

In certain embodiments, the database is a post-release structured query language database.

Further disclosed herein is a computerized method for automatically renewing a government document prior to its expiration date, the method comprising the following steps in order:
storing, in a database associated with a server, an expiration date of a government document from a government agency;
calculating a filing date set to a time period before the expiration date;
automatically retrieving previously stored user data relevant to the government document from the database;
automatically populating a new governmental application for the government document with the pre-stored user data;
automatically notifying the user, via a user device, to review the auto-populated new governmental application via a user interface on the user device before the filing date; and
submitting the reviewed new governmental application to a server of the government agency by the filing date.

In certain embodiments, the time period is nine months to one day.

In certain embodiments, the time period is 7 months to 3 months.

In certain embodiments, the time period is six months.

In certain embodiments, the time period before the expiration date is when the renewal period for the government document opens.

In certain embodiments, the time period accounts for processing time.

In certain embodiments, the user device is chosen from a smartphone, a tablet, or a computer.

In certain embodiments, the method further comprises generating a reminder notification and transmitting the reminder notification to the user device before the filing date.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the database is a post-release structured query language database.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

In certain embodiments, the notification step includes providing the user with a summary of the changes made to the pre-stored user data, if any.

Further disclosed herein is a computer system for automatically renewing a government document, the system comprising:
a server configured to store an expiration date of a government document from a government agency in a database associated with the server;
a processor configured to calculate a filing date set to a predetermined time period before the expiration date;
a data retrieval module configured to retrieve pre-stored user data relevant to the government document from the database;
an auto-population module configured to auto-populate a new governmental application for the government document with the pre-stored user data;
a notification module configured to notify a user, via a user device, to review the auto-populated new governmental application via a user interface on the user device before the filing date; and
a submission module configured to submit the reviewed new governmental application to a server of the government agency by the filing date.

In certain embodiments, the time period is nine months to one day.

In certain embodiments, the time period is 7 months to 3 months.

In certain embodiments, the time period is six months.

In certain embodiments, the time period before the expiration date is when the renewal period for the government document opens.

In certain embodiments, the time period accounts for processing time.

In certain embodiments, the user device is chosen from a smartphone, a tablet, or a computer.

In certain embodiments, the method further comprises generating a reminder notification and transmitting the reminder notification to the user device before the filing date.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the database is a post-release structured query language database.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

In certain embodiments, the notification step includes providing the user with a summary of the changes made to the pre-stored user data, if any.

Further disclosed herein is a non-transitory computer-readable medium storing instructions that, when executed by one or more processors, cause a computer system to perform a method for automatically renewing a government document, the method comprising the following steps in order:
storing, at a server, an expiration date of a government document from a government agency in a database associated with the server;
calculating a filing date set to a predetermined time period before the expiration date;
retrieving pre-stored user data relevant to the government document from the database;
auto-populating a new governmental application for the government document with the pre-stored user data;
notifying the user, via a user device, to review the auto-populated new governmental application via a user interface on the user device before the filing date; and
submitting the reviewed new governmental application to a server of the government agency by the filing date.

In certain embodiments, the time period is nine months to one day.

In certain embodiments, the time period is 7 months to 3 months.

In certain embodiments, the time period is six months.

In certain embodiments, the time period before the expiration date is when the renewal period for the government document opens.

In certain embodiments, the time period accounts for processing time.

In certain embodiments, the user device is chosen from a smartphone, a tablet, or a computer.

In certain embodiments, the method further comprises generating a reminder notification and transmitting the reminder notification to the user device before the filing date.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the database is a post-release structured query language database.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

In certain embodiments, the notification step includes providing the user with a summary of the changes made to the pre-stored user data, if any.

Further disclosed herein is a computerized method for providing automated replacement of a government document, the method comprising the following steps in order:
storing, in a database, user profile data and a governmental application previously completed by a user for an original government document at a government agency;
receiving, from the user via a user device, a request for a replacement of the original government document;
generating a new government document application using user profile data and the previously completed governmental application; and
submitting the generated new government document application to the government agency for processing.

In certain embodiments, the original government document has been lost, stolen, or damaged.

In certain embodiments, the method further comprises providing an option for the user to request the replacement of the original government document from an account of the user.

In certain embodiments, the replacement request is done with a single click.

In certain embodiments, the single click comprises an autogenerated reason for replacing the original document.

In certain embodiments, the database is a post-release structured query language database.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

Further disclosed herein is a computer system for providing automated replacement of a government document, the system comprising:
a database configured to store user profile data and a governmental application previously completed by a user for an original government document at a government agency;
a server configured to receive, from the user via a user device, a request for a replacement of the original government document;
a processing module configured to generate a new government document application using the user profile data and the previously completed governmental application; and
a submission module configured to submit the generated new government document application to the government agency for processing.

In certain embodiments, the original government document has been lost, stolen, or damaged.

In certain embodiments, the method further comprises providing an option for the user to request the replacement of the original government document from an account of the user.

In certain embodiments, the replacement request is done with a single click.

In certain embodiments, the single click comprises an autogenerated reason for replacing the original document.

In certain embodiments, the database is a post-release structured query language database.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

Further disclosed herein is a non-transitory computer-readable medium storing instructions that, when executed by one or more processors, cause a computer system to perform a method for providing automated replacement of a government document, the method comprising the following steps in order:
storing, in a database, user profile data and a governmental application previously completed by a user for an original government document at a government agency;
receiving, from the user via a user device, a request for a replacement of the original government document;
generating a new government document application using user profile data and the previously completed governmental application; and
submitting the generated new government document application to the government agency for processing.

In certain embodiments, the original government document has been lost, stolen, or damaged.

In certain embodiments, the method further comprises providing an option for the user to request the replacement of the original government document from an account of the user.

In certain embodiments, the replacement request is done with a single click.

In certain embodiments, the single click comprises an autogenerated reason for replacing the original document.

In certain embodiments, the database is a post-release structured query language database.

In certain embodiments, the notifying step comprises allowing the user to update the auto-populated new government document.

In certain embodiments, the method further comprises generating a confirmation notice and sending the confirmation notice to the user device indicating successful filing of the new governmental application.

In certain embodiments, the server validates the pre-stored user data against an external data source before auto-populating the new governmental application.

In certain embodiments, the method further comprises encrypting the user data during retrieval, storage, and transmission to ensure data security.

In certain embodiments, the user is authenticated using multi-factor authentication when accessing the user interface to review the auto-populated new governmental application.

In certain embodiments, the method further comprises generating and storing an audit trail of the steps taken to prepare and submit the new governmental application.

In certain embodiments, the user interface provides real-time feedback on the status of the governmental application after submission.

In certain embodiments, the method further comprises recommending additional related services to the user based on the renewal of the government document.

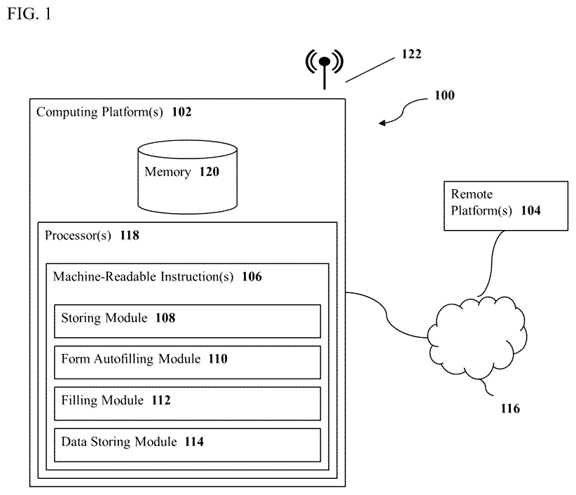

FIG. 1 illustrates a system configured for automatically completing forms per one or more embodiments. In some cases, system 100 may include one or more computing platforms 102. The one or more remote computing platforms 102 may be communicably coupled with one or more remote platforms 104. In some cases, users may access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of storing module 108, form autofilling module 110, filling module 112, data storing module 114, and/or other modules.

Storing module 108 may be configured to store data filled by a user into a first form to encrypted cloud storage. Form autofilling module 110 may be configured to autofill a second form having at least one field that matches a field from the first form with the data requested from the encrypted cloud storage in the at least one matching field. Form autofilling module 110 may be further configured to autofill a form from two or more members of the same household having at least one field that matches a field from the first form with the data requested from the encrypted cloud storage in the at least one matching field. Filling module 112 may be configured to fill in by the user non-matching fields with new data. Data storing module 114 may be configured to store the new data to the encrypted cloud storage.

In some cases, the one or more computing platforms 102 may be communicatively coupled to the remote platform(s) 104. In some cases, the communicative coupling may include communicative coupling through a networked environment 116. The networked environment 116 may be a radio access network, such as LTE or 5G, a local area network (LAN), a wide area network (WAN) such as the Internet, or wireless LAN (WLAN), for example. It will be appreciated that this is not intended to be limiting and that the scope of this disclosure includes implementations in which one or more computing platforms 102 and remote platform(s) 104 may be operatively linked via some other communication coupling. The one or more computing platforms 102 may be configured to communicate with the networked environment 116 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices.

In an embodiment, system 100 may also include one or more hosts or servers, such as the one or more remote platforms 104 connected to the networked environment 116 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 118 for processing information and executing instructions or operations. One or more processors 118 may be any general or specific purpose processor. In some cases, multiple processors 118 may be used according to other embodiments. The one or more processors 118 may include one or more general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 118 may be remote from the one or more computing platforms 102, such as disposed within a remote platform like the one or more remote platforms 118 of FIG. 1.

The one or more processors 118 may perform functions for the operation of system 100, which may include, for example, precoding of antenna gain/phase parameters, encoding, and decoding of individual bits forming a communication message, formatting of information, and overall control of the one or more computing platforms 102, including processes related to managing communication resources.

The one or more computing platforms 102 may further include or be coupled to a memory 120 (internal or external), which may be coupled to one or more processors 118, for storing information and instructions that may be executed by one or more processors 118. Memory 120 may be one or more memories and of any type suitable to the local application environment and may be implemented using any suitable volatile or nonvolatile data storage technology such as a semiconductor-based memory device, a magnetic memory device and system, an optical memory device, and system, fixed memory, and removable memory. For example, memory 120 can consist of any combination of random access memory (RAM), read-only memory (ROM), static storage such as a magnetic or optical disk, hard disk drive (HDD), or any other type of non-transitory machine or computer-readable media. The instructions stored in memory 120 may include program instructions or computer program code that, when executed by one or more processors 118, enable the one or more computing platforms 102 to perform tasks described herein.

In some embodiments, one or more computing platforms 102 may also include or be coupled to one or more antennas for transmitting and receiving signals and/or data to and from one or more computing platforms 102. The one or more antennas may be configured to communicate via, for example, a plurality of radio interfaces that may be coupled to the one or more antennas. The radio interfaces may correspond to a plurality of radio access technologies, including one or more of LTE, 5G, WLAN, Bluetooth, near field communication (NFC), radiofrequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for transmission via one or more downlinks and to receive symbols (for example, via an uplink).

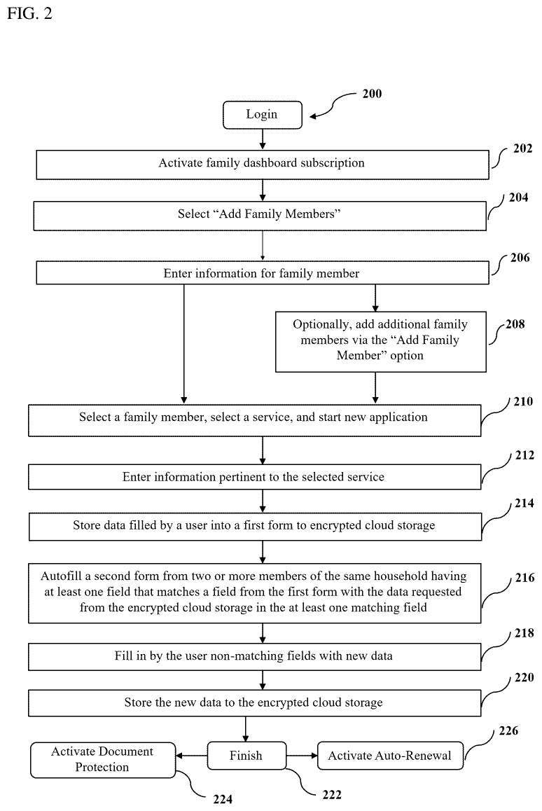

FIG. 2 illustrate an example flow diagram of a method 200, according to one embodiment. Method 200 may include activating a family dashboard subscription at block 202. Method 200 may include selecting “Add Family Members” from the options on the dashboard at block 204. The method 200 may include filling in information for one or more family members at block 206. Method 200 may include optionally adding additional members via the “Add Family Member” option on the dashboard at block 208. Method 200 may include selecting a family member, selecting a service, and starting a new application at block 210. Method 200 may include entering information pertinent to the selected service at block 212. Method 200 may include storing data filled by a user into a first form to encrypted cloud storage at block 214. Method 200 may include autofilling a second form from two or more members of the same household having at least one field that matches a field from the first form with the data requested from the encrypted cloud storage in the at least one matching field at block 216. Method 200 may include the user filling in non-matching fields with new data at block 218. Method 200 may include storing the new data filled by a user to encrypted cloud storage at block 220. Method 200 may include completing the application process at block 222. Method 200 may include activating document protection at block 224. Method 200 may include activating auto-renewal at block 226.

In some cases, method 200 may be performed by one or more hardware processors, such as the processors 118 of FIG. 1, configured by machine-readable instructions, such as the machine-readable instructions 106 of FIG. 1. In this aspect, method 200 may be configured to be implemented by the modules, such as the modules 108, 110, 112, and/or 114 discussed above in FIG. 1.

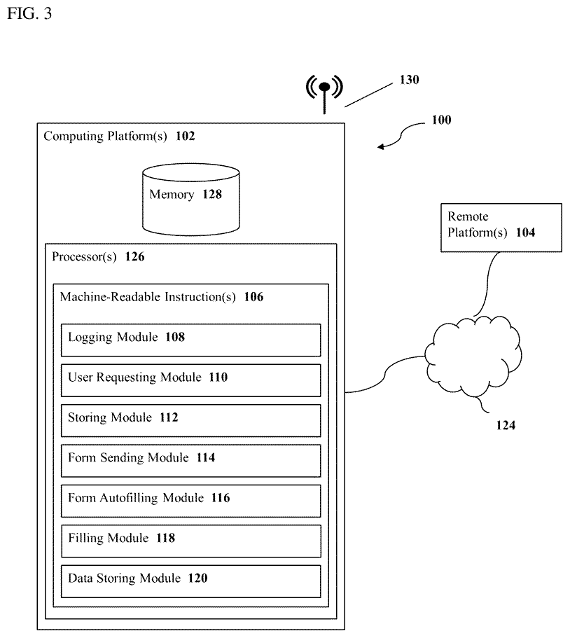

FIG. 3 illustrates a system configured for automatically completing forms per one or more embodiments. In some cases, system 100 may include one or more computing platforms 102. The one or more remote computing platforms 102 may be communicably coupled with one or more remote platforms 104. In some cases, users may access the system 100 via the remote platform(s) 104.

One or more computing platforms 102 may be configured by machine-readable instructions 106. Machine-readable instructions 106 may include modules. The modules may be implemented as one or more functional logic, hardware logic, electronic circuitry, software modules, and the like. The modules may include one or more logging module 108, the user requesting module 110, storing module 112, form sending module 114, form autofilling module 116 capable of autofilling forms from two or more users from the same household, filling module 118, data storing module 120, and/or other modules.

Logging module 108 may be configured to log, by the user, into a platform for a first form having fields. The user requesting module 110 may be configured to request the user to accept the terms and conditions to permit to store the user's dated filled into the first form. Storing module 112 may be configured to store data filled by a user into a first form to encrypted cloud storage. Form sending module 114 may be configured to send the filled first form to the user. Form autofilling module 116 may be configured to autofill a form from two or more users from the same household having at least one field that matches a field from the first form with the data requested from the encrypted cloud storage in the at least one matching field. Filling module 118 may be configured to fill in by the user non-matching fields with new data. Data storing module 120 may be configured to store the new data to the encrypted cloud storage.

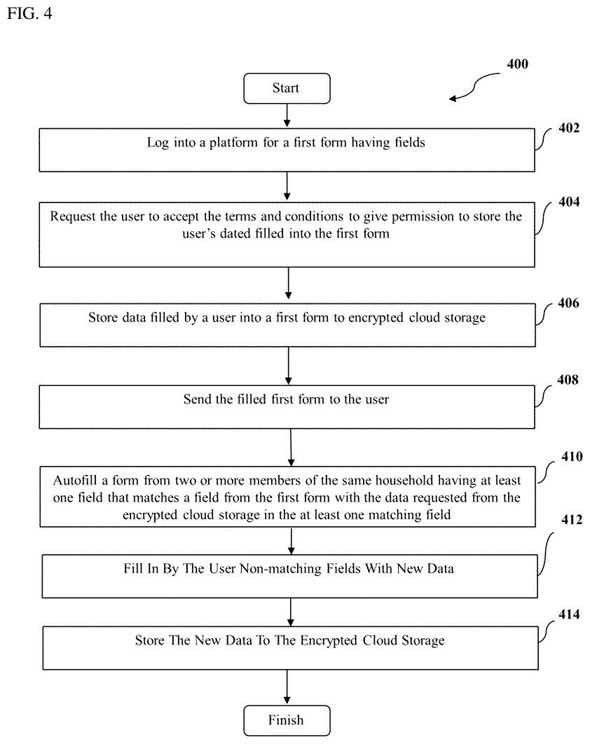

FIG. 4 illustrates an example flow diagram of a method 400, according to one embodiment. Method 240 may include logging, by the user, into a platform for a first form having fields at block 402. Method 400 may include requesting the user accept the terms and conditions to permit to store the user's dated filled into the first form at block 204. Method 400 may include storing data filled by a user into a first form to encrypted cloud storage at block 406. Method 400 may include sending the filled first form to the user at block 408. Method 400 may include autofilling a form from two or more users from the same household having at least one field that matches a field from the first form with the data requested from the encrypted cloud storage in the at least one matching field at block 410. Method 400 may include filling in by the user non-matching fields with new data at block 412. Method 400 may include storing the new data to the encrypted cloud storage at block 414.

Without wishing to be bound by theory, not having to refill form data that has previously been captured increases the efficiency of use for a general purpose computer. The data remain encrypted between forms and do not need to be copied into the clipboard function of the general purpose computer. Similarly, in certain embodiments, sending the first filled form to the user increases efficiency of the form filling operation by providing the user with a copy of the records used to complete the selected governmental application.

In some cases, method 400 may be performed by one or more hardware processors, such as the processors 426 of FIG. 3, configured by machine-readable instructions, such as the machine-readable instructions 106 of FIG. 3. In this aspect, method 400 may be configured to be implemented by the modules, such as the modules 108, 110, 112, 114, 116, 118, and/or 120, discussed above in FIG. 3.

A programming interface (or, more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of another component(s). The term “segment of code” in the preceding sentence is intended to include one or more instructions or lines of code. It includes, e.g., code modules, objects, subroutines, functions, and so on, regardless of the terminology applied or whether the code segments are separately compiled, or whether the code segments are provided as a source, intermediate, or object code, whether the code segments are used in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium is wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment accesses functionality performed by a second code segment. Any or all these aspects may be important in a given situation, e.g., depending on whether the code segments are part of a system in a loosely coupled or tightly coupled configuration. So this list should be considered illustrative and non-limiting.

This notion of a programming interface is known to those skilled in the art and is clear from the provided detailed description. Some illustrative implementations of a programming interface may also include factoring, redefinition, inline coding, divorce, and rewriting, to name a few. There are, however, other ways to implement a programming interface. Unless expressly excluded, these are intended to be encompassed by the claims set forth at the end of this specification.

Embodiments within the scope of the present disclosure also include computer-readable media and computer-readable storage media for carrying or having computer-executable instructions or data structures stored thereon. Such computer-readable media can be any available media accessed by a general or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general-purpose or special-purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing aspects of the present disclosure.

All references, patents or applications, US or foreign, cited in the application are because of this incorporated by reference as if written herein in their entireties. Where any inconsistencies arise, the material disclosed herein controls.

From the preceding description, one skilled in the art can easily ascertain the essential characteristics of this invention. Without departing from the spirit and scope thereof, various changes and modifications of the invention adapt it to various usages and conditions.

What is claimed is:

1. A computerized method for managing and sharing user profile information within a family dashboard, the method comprising:
storing, in a database, user profile data for two or more members within a household to define a family dashboard;
establishing at least one overlapping field within the user profiles of the members;
automatically updating the at least one overlapping field within the user profiles of the other members of the household with data from any one of the user profiles;
retrieving the at least one updated overlapping field from the database when generating for a member a governmental application from a government agency; and
auto-populating the governmental application for the member with the at least one retrieved overlapping field.

2. The method of claim 1, wherein encrypted data filled by a user into a first form is stored to encrypted cloud storage.

3. The method of claim 2, wherein a second form having at least one field matching a field from the first form with the stored encrypted data from the encrypted cloud storage is autofilled in the at least one matching field.

4. The method of claim 3, wherein at least one of the first form and the second form are governmental applications from different government agencies.

5. The method of claim 4, wherein the user fills in any non-matching fields with new encrypted data; storing the new encrypted data to the encrypted cloud storage.

6. The method of claim 5, wherein the user or a user's signature is verified using a vital document, a third-party signature service, or an electronic token exchange.

7. The method of claim 6, further comprising logging, by the user, into a platform for the first form having fields.

8. The method of claim 6, further comprising sending the filled first form to the user.

9. The method of claim 6, further comprising providing to the user a set of computer-executed instructions that, when executed by a user's user device, generate a user interface displayable on an electronic display coupled to the user's user device.

10. The method of claim 6, further comprises verifying that the encrypted data and the new encrypted data are correct per a government standard with a computer-implemented verification process.

11. The method of claim 6, wherein the verifying step uses a vital document.

12. The method of claim 11, wherein the vital document is an image file or a certified electronic copy from an issuing government authority.

13. The method of claim 12, wherein the vital document is chosen from a birth certificate, driver's license, travel visa, or passport.

14. The method of claim 12, wherein the vital document is saved in the encrypted cloud drive for the user to use later to verify the user's identity, to verify the user's signature, or to submit as supporting documentation for a government application.

15. The method of claim 6, wherein the verifying step uses a third-party signature service.

16. The method of claim 6, wherein the verifying step uses an electronic token exchange.

17. The method of claim 16, wherein the electronic token exchange comprises a public or private key.

18. The method of claim 6, wherein two or more second forms having at least one field matching a field from the first form are autofilled with the stored encrypted cloud storage in the at least one matching field of the two or more second forms.

19. The method of claim 6, further comprising displaying a completion status of further forms, which is automatically updated when the second form is completed.

20. The method of claim 1, wherein the members within the household belong to a family.

21. The method of claim 1, wherein the two or more members comprise one primary user and one or more secondary users.

22. The method of claim 21, wherein the primary user modifies data in the fields for all members included in the dashboard.

23. The method of any of claims 21 to 22, wherein the secondary users are chosen from spouse, child, parent, and sibling.

24. The method of claim 21, further comprising allowing the primary user to approve or modify the auto-populated governmental application for the one or more secondary users before submission.

25. The method of claim 21 or 22, wherein the overlapping fields include information such as family name, home address, and emergency contact details.

26. The method of any one of claims 1 to 25, further comprising receiving, from a user via a user device, a completed governmental application for one member, the completed governmental application including data for the overlapping field.

27. The method of any one of claims 1 to 26, wherein the user profiles of the members are linked based on a familial relationship identifier.

28. The method of any one of claims 1 to 27, further comprising submitting the auto-populated governmental application to a server of the government agency.

29. The method of any one of claims 1 to 28, wherein the family dashboard provides a summary view of all pending and completed governmental applications for the household members.

30. The method of any one of claims 1 to 29, further comprising displaying personalized recommendations for additional governmental services based on application history.

31. The method of claim 28, wherein the recommendations include renewal reminders for expiring documents, updates on new governmental programs, and suggestions for related services.

32. The method of any one of claims 29 to 31, further comprising tracking and displaying status of each household member's governmental application in real-time on the family dashboard.

33. The method of any one of claims 29 to 32, further comprising a secure messaging feature allowing household members to communicate with a customer support representative through the family dashboard.

34. The method of any one of claims 29 to 33, further comprising an activity log that logs all actions taken on each household member's profile and governmental applications.

35. The method of any one of claims 29 to 34, wherein the family dashboard provides an option to schedule future governmental applications and set deadline reminders.

36. The method of any one of claims 29 to 35, wherein the family dashboard provides an option to delete family members.

37. The method of any one of claims 1 to 36, wherein the database is a post-release structured query language database.

38. A computer system for managing and sharing user profile information within a family dashboard, the system comprising:
a database configured to store user profile data for two or more members within a household to define a family dashboard;
a processor configured to establish at least one overlapping field within the user profiles of the members;
a module configured to automatically update the at least one overlapping field within the user profiles of the other members of the household with data from any one of the user profiles;
a retrieval module configured to retrieve the at least one updated overlapping field from the database when generating for a member a governmental application from a government agency; and
an auto-population module configured to auto-populate the governmental application for the member with the at least one retrieved overlapping field.

39. The system of claim 38, wherein encrypted data filled by a user into a first form is stored to encrypted cloud storage.

40. The system of claim 39, wherein a second form having at least one field matching a field from the first form with the stored encrypted data from the encrypted cloud storage is autofilled in the at least one matching field.

41. The system of claim 40, wherein at least one of the first form and the second form are governmental applications from different government agencies.

42. The system of claim 41, wherein the user fills in any non-matching fields with new encrypted data; storing the new encrypted data to the encrypted cloud storage.

43. The system of claim 42, wherein the user or a user's signature is verified using a vital document, a third-party signature service, or an electronic token exchange.

44. The system of claim 43, further comprising logging, by the user, into a platform for the first form having fields.

45. The system of claim 43, further comprising sending the filled first form to the user.

46. The system of claim 43, further comprising providing to the user a set of computer-executed instructions that, when executed by a user's user device, generate a user interface displayable on an electronic display coupled to the user's user device.

47. The system of claim 43, further comprises verifying that the encrypted data and the new encrypted data are correct per a government standard with a computer-implemented verification process.

48. The system of claim 43, wherein the verifying step uses a vital document.

49. The system of claim 48, wherein the vital document is an image file or a certified electronic copy from an issuing government authority.

50. The system of claim 49, wherein the vital document is chosen from a birth certificate, driver's license, travel visa or passport.

51. The system of claim 49, wherein the vital document is saved in the encrypted cloud drive for the user to use later to verify the user's identity, to verify the user's signature, or to submit as supporting documentation for a government application.

52. The system of claim 43, wherein the verifying step uses a third-party signature service.

53. The system of claim 43, wherein the verifying step uses an electronic token exchange.

54. The system of claim 53, wherein the electronic token exchange comprises a public or private key.

55. The system of claim 43, wherein two or more second forms having at least one field matching a field from the first form are autofilled with the stored encrypted cloud storage in the at least one matching field of the two or more second forms.

56. The system of claim 43, further comprising displaying a completion status of further forms, which is automatically updated when the second form is completed.

57. The system of claim 38, wherein the members within the household belong to a family.

58. The system of claim 36, wherein the two or more members comprise one primary user and one or more secondary users.

59. The system of claim 58, wherein the primary user modifies data in the fields for all members included in the dashboard.

60. The system of any of claims 58 to 59, wherein the secondary users are chosen from spouse, child, parent, and sibling.

61. The system of claim 58, further comprising allowing the primary user to approve or modify the auto-populated governmental application for the one or more secondary users before submission.

62. The system of claim 57, wherein the overlapping fields include information such as family name, home address, and emergency contact details.

63. The system of any one of claims 36 to 62, further comprising receiving, from a user via a user device, a completed governmental application for one member, the completed governmental application including data for the overlapping field.

64. The system of any one of claims 36 to 63, wherein the user profiles of the members are linked based on a familial relationship identifier.

65. The system of any one of claims 36 to 64, further comprising submitting the auto-populated governmental application to a server of the government agency.

66. The system of any one of claims 36 to 65, wherein the family dashboard provides a summary view of all pending and completed governmental applications for the household members.

67. The system of any one of claims 36 to 66, further comprising displaying personalized recommendations for additional governmental services based on application history.

68. The system of claim 67, wherein the recommendations include renewal reminders for expiring documents, updates on new governmental programs, and suggestions for related services.

69. The system of any one of claims 66 to 68, further comprising tracking and displaying status of each household member's governmental application in real-time on the family dashboard.

70. The system of any one of claims 66 to 69, further comprising a secure messaging feature allowing household members to communicate with a customer support representative through the family dashboard.

71. The system of any one of claims 66 to 70, further comprising an activity log that logs all actions taken on each household member's profile and governmental applications.

72. The system of any one of claims 66 to 71, wherein the family dashboard provides an option to schedule future governmental applications and set deadline reminders.

73. The system of any one of claims 66 to 72, wherein the family dashboard provides an option to delete family members.

74. The system of any one of claims 66 to 73, wherein the database is a post-release structured query language database.

75. A non-transitory computer-readable medium storing instructions that, when executed by one or more processors, cause a computer system to perform a method for managing and sharing user profile information within a family dashboard, the method comprising:
storing, in a database, user profile data for two or more members within a household to define a family dashboard;
establishing at least one overlapping field within the user profiles of the members;
automatically updating the at least one overlapping field within the user profiles of the other members of the household with data from any one of the user profiles;
retrieving the at least one updated overlapping field from the database when generating for a member a governmental application from a government agency; and
auto-populating the governmental application for the member with the at least one retrieved overlapping field.

76. The medium of claim 75, wherein encrypted data filled by a user into a first form is stored to encrypted cloud storage.

77. The medium of claim 76, wherein a second form having at least one field matching a field from the first form with the stored encrypted data from the encrypted cloud storage is autofilled in the at least one matching field.

78. The medium of claim 77, wherein at least one of the first form and the second form are governmental applications from different government agencies.

79. The medium of claim 78, wherein the user fills in any non-matching fields with new encrypted data; storing the new encrypted data to the encrypted cloud storage.

80. The medium of claim 79, wherein the user or a user's signature is verified using a vital document, a third-party signature service, or an electronic token exchange.

81. The medium of claim 80, further comprising logging, by the user, into a platform for the first form having fields.

82. The medium of claim 80, further comprising sending the filled first form to the user.

83. The medium of claim 80, further comprising providing to the user a set of computer-executed instructions that, when executed by a user's user device, generate a user interface displayable on an electronic display coupled to the user's user device.

84. The medium of claim 80, further comprises verifying that the encrypted data and the new encrypted data are correct per a government standard with a computer-implemented verification process.

85. The medium of claim 80, wherein the verifying step uses a vital document.

86. The medium of claim 85, wherein the vital document is an image file or a certified electronic copy from an issuing government authority.

87. The medium of claim 86, wherein the vital document is chosen from a birth certificate, driver's license, travel visa or passport.

88. The medium of claim 86, wherein the vital document is saved in the encrypted cloud drive for the user to use later to verify the user's identity, to verify the user's signature, or to submit as supporting documentation for a government application.

89. The medium of claim 80, wherein the verifying step uses a third-party signature service.

90. The medium of claim 80, wherein the verifying step uses an electronic token exchange.

91. The medium of claim 90, wherein the electronic token exchange comprises a public or private key.

92. The medium of claim 80, wherein two or more second forms having at least one field matching a field from the first form are autofilled with the stored encrypted cloud storage in the at least one matching field of the two or more second forms.

93. The medium of claim 80, further comprising displaying a completion status of further forms, which is automatically updated when the second form is completed.

94. The medium of claim 75, wherein the members within the household belong to a family.

95. The medium of claim 75, wherein the two or more members comprise one primary user and one or more secondary users.

96. The method of claim 95, wherein the primary user modifies data in the fields for all members included in the dashboard.

97. The method of any of claims 95 to 96, wherein the secondary users are chosen from spouse, child, parent, and sibling.

98. The method of claim 95, further comprising allowing the primary user to approve or modify the auto-populated governmental application for the one or more secondary users before submission.

99. The medium of claim 94, wherein the overlapping fields include information such as family name, home address, and emergency contact details.

100. The medium of any one of claims 75 to 99, further comprising receiving, from a user via a user device, a completed governmental application for one member, the completed governmental application including data for the overlapping field.

101. The medium of any one of claims 75 to 100, wherein the user profiles of the members are linked based on a familial relationship identifier.

102. The medium of any one of claims 75 to 101, further comprising submitting the auto-populated governmental application to a server of the government agency.

103. The medium of any one of claims 75 to 102, wherein the family dashboard provides a summary view of all pending and completed governmental applications for the household members.

104. The medium of any one of claims 93 to 103, further comprising displaying personalized recommendations for additional governmental services based on application history.

105. The medium of claim 104, wherein the recommendations include renewal reminders for expiring documents, updates on new governmental programs, and suggestions for related services.

106. The medium of any one of claims 75 to 105, further comprising tracking and displaying status of each household member's governmental application in real-time on the family dashboard.

107. The medium of any one of claims 75 to 106, further comprising a secure messaging feature allowing household members to communicate with a customer support representative through the family dashboard.

108. The medium of any one of claims 75 to 107, further comprising an activity log that logs all actions taken on each household member's profile and governmental applications.

109. The medium of any one of claims 75 to 108, wherein the family dashboard provides an option to schedule future governmental applications and set deadline reminders.

110. The medium of any one of claims 75 to 109, wherein the family dashboard provides an option to delete family members.

111. The medium of any one of claims 75 to 110, wherein the database is a post-release structured query language database.

112. A computerized method for automatically renewing a government document prior to its expiration date, the method comprising the following steps in order:
storing, in a database associated with a server, an expiration date of a government document from a government agency;
calculating a filing date set to a time period before the expiration date;
automatically retrieving previously stored user data relevant to the government document from the database;
automatically populating a new governmental application for the government document with the pre-stored user data;
automatically notifying the user, via a user device, to review the auto-populated new governmental application via a user interface on the user device before the filing date; and
submitting the reviewed new governmental application to a server of the government agency by the filing date.

113. The method of claim 112, wherein the time period is six months.

114. The method of claim 112, where the time period before the expiration date is when the renewal period for the government document opens.

115. The method of any one of claims 112 to 114, wherein the time period accounts for processing time.

116. The method of any one of claims 112 to 115, wherein the user device is chosen from a smartphone, a tablet, or a computer.

117. The method of any one of claims 112 to 116, further comprising generating a reminder notification and transmitting the reminder notification to the user device before the filing date.

118. The method of any one of claims 112 to 117, wherein the notifying step comprises allowing the user to update the auto-populated new government document.

119. The method of any one of claims 112 to 118, further comprising generating a confirmation notice and sending the confirmation notice to the user device indicating successful filing of the new governmental application.

120. The method of any one of claims 112 to 119, wherein the database is a post-release structured query language database.

121. The method of any one of claims 112 to 120, wherein the server validates the pre-stored user data against an external data source before auto-populating the new governmental application.

122. The method of any one of claims 112 to 121, further comprising encrypting the user data during retrieval, storage, and transmission to ensure data security.

123. The method of any one of claims 112 to 122, wherein the user is authenticated using multi-factor authentication when accessing the user interface to review the auto-populated new governmental application.

124. The method of any one of claims 112 to 123, further comprising generating and storing an audit trail of the steps taken to prepare and submit the new governmental application.

125. The method of any one of claims 112 to 124, wherein the user interface provides real-time feedback on the status of the governmental application after submission.

126. The method of any one of claims 112 to 125, further comprising recommending additional related services to the user based on the renewal of the government document.

127. The method of any one of claims 112 to 126, wherein the notification step includes providing the user with a summary of the changes made to the pre-stored user data, if any.

128. A computer system for automatically renewing a government document, the system comprising:
a server configured to store an expiration date of a government document from a government agency in a database associated with the server;
a processor configured to calculate a filing date set to a predetermined time period before the expiration date;
a data retrieval module configured to retrieve pre-stored user data relevant to the government document from the database;
an auto-population module configured to auto-populate a new governmental application for the government document with the pre-stored user data;
a notification module configured to notify a user, via a user device, to review the auto-populated new governmental application via a user interface on the user device before the filing date; and
a submission module configured to submit the reviewed new governmental application to a server of the government agency by the filing date.

129. The system of claim 128, wherein the time period is six months.

130. The system of claim 128, where the time period before the expiration date is when the renewal period for the government document opens.

131. The system of any one of claims 128 to 130, wherein the time period accounts for processing time.

132. The system of any one of claims 128 to 131, wherein the user device is chosen from a smartphone, a tablet, or a computer.

133. The system of any one of claims 128 to 132, further comprising generating a reminder notification and transmitting the reminder notification to the user device before the filing date.

134. The system of any one of claims 128 to 133, wherein the notifying step comprises allowing the user to update the auto-populated new government document.

135. The system of any one of claims 128 to 134, further comprising generating a confirmation notice and sending the confirmation notice to the user device indicating successful filing of the new governmental application.

136. The system of any one of claims 128 to 135, wherein the database is a post-release structured query language database.

137. The system of any one of claims 128 to 136, wherein the server validates the pre-stored user data against an external data source before auto-populating the new governmental application.

138. The system of any one of claims 128 to 137, further comprising encrypting the user data during retrieval, storage, and transmission to ensure data security.

139. The system of any one of claims 128 to 138, wherein the user is authenticated using multi-factor authentication when accessing the user interface to review the auto-populated new governmental application.

140. The system of any one of claims 128 to 139, further comprising generating and storing an audit trail of the steps taken to prepare and submit the new governmental application.

141. The system of any one of claims 128 to 140, wherein the user interface provides real-time feedback on the status of the governmental application after submission.

142. The system of any one of claims 128 to 141, further comprising recommending additional related services to the user based on the renewal of the government document.

143. The system of any one of claims 128 to 142, wherein the notification step includes providing the user with a summary of the changes made to the pre-stored user data, if any.

144. A non-transitory computer-readable medium storing instructions that, when executed by one or more processors, cause a computer system to perform a method for automatically renewing a government document, the method comprising the following steps in order:
storing, at a server, an expiration date of a government document from a government agency in a database associated with the server;
calculating a filing date set to a predetermined time period before the expiration date;
retrieving pre-stored user data relevant to the government document from the database;
auto-populating a new governmental application for the government document with the pre-stored user data;
notifying the user, via a user device, to review the auto-populated new governmental application via a user interface on the user device before the filing date; and
submitting the reviewed new governmental application to a server of the government agency by the filing date.

145. The medium of claim 144, wherein the time period is six months.

146. The medium of claim 144, where the time period before the expiration date is when the renewal period for the government document opens.

147. The medium of any one of claims 144 to 146, wherein the time period accounts for processing time.

148. The medium of any one of claims 144 to 147, wherein the user device is chosen from a smartphone, a tablet, or a computer.

149. The medium of any one of claims 144 to 148, further comprising generating a reminder notification and transmitting the reminder notification to the user device before the filing date.

150. The medium of any one of claims 144 to 149, wherein the notifying step comprises allowing the user to update the auto-populated new government document.

151. The medium of any one of claims 144 to 150, further comprising generating a confirmation notice and sending the confirmation notice to the user device indicating successful filing of the new governmental application.

152. The medium of any one of claims 144 to 151, wherein the database is a post-release structured query language database.

153. The medium of any one of claims 144 to 152, wherein the server validates the pre-stored user data against an external data source before auto-populating the new governmental application.

154. The medium of any one of claims 144 to 153, further comprising encrypting the user data during retrieval, storage, and transmission to ensure data security.

155. The medium of any one of claims 144 to 154, wherein the user is authenticated using multi-factor authentication when accessing the user interface to review the auto-populated new governmental application.

156. The medium of any one of claims 144 to 155, further comprising generating and storing an audit trail of the steps taken to prepare and submit the new governmental application.

157. The medium of any one of claims 144 to 156, wherein the user interface provides real-time feedback on the status of the governmental application after submission.

158. The medium of any one of claims 144 to 157, further comprising recommending additional related services to the user based on the renewal of the government document.

159. The medium of any one of claims 144 to 158, wherein the notification step includes providing the user with a summary of the changes made to the pre-stored user data, if any.

160. A computerized method for providing automated replacement of a government document, the method comprising the following steps in order:
storing, in a database, user profile data and a governmental application previously completed by a user for an original government document at a government agency;
receiving, from the user via a user device, a request for a replacement of the original government document;
generating a new government document application using user profile data and the previously completed governmental application; and
submitting the generated new government document application to the government agency for processing.

161. The method of claim 160, wherein the original government document has been lost, stolen, or damaged.

162. The method of any one of claims 160 to 161, further comprising providing an option for the user to request the replacement of the original government document from an account of the user.

163. The method of claim 162, wherein the replacement request is done with a single click.

164. The method of claim 163, wherein the single click comprises an autogenerated reason for replacing the original document.

165. The method of any one of claims 160 to 164, wherein the database is a post-release structured query language database.

166. The method of any one of claims 160 to 165, wherein the notifying step comprises allowing the user to update the auto-populated new government document.

167. The method of any one of claims 160 to 166, further comprising generating a confirmation notice and sending the confirmation notice to the user device indicating successful filing of the new governmental application.

168. The method of any one of claims 160 to 167, wherein the server validates the pre-stored user data against an external data source before auto-populating the new governmental application.

169. The method of any one of claims 160 to 168, further comprising encrypting the user data during retrieval, storage, and transmission to ensure data security.

170. The method of any one of claims 160 to 169, wherein the user is authenticated using multi-factor authentication when accessing the user interface to review the auto-populated new governmental application.

171. The method of any one of claims 160 to 170, further comprising generating and storing an audit trail of the steps taken to prepare and submit the new governmental application.

172. The method of any one of claims 160 to 171, wherein the user interface provides real-time feedback on the status of the governmental application after submission.

173. The method of any one of claims 160 to 172, further comprising recommending additional related services to the user based on the renewal of the government document.

174. A computer system for providing automated replacement of a government document, the system comprising:
a database configured to store user profile data and a governmental application previously completed by a user for an original government document at a government agency;
a server configured to receive, from the user via a user device, a request for a replacement of the original government document;
a processing module configured to generate a new government document application using the user profile data and the previously completed governmental application; and
a submission module configured to submit the generated new government document application to the government agency for processing.

175. The system of claim 174, wherein the original government document has been lost, stolen, or damaged.

176. The system of any one of claims 174 to 175, further comprising providing an option for the user to request the replacement of the original government document from an account of the user.

177. The system of claim 176, wherein the replacement request is done with a single click.

178. The system of claim 177, wherein the single click comprises an autogenerated reason for replacing the original document.

179. The system of any one of claims 174 to 178, wherein the database is a post-release structured query language database.

180. The system of any one of claims 174 to 179, wherein the notifying step comprises allowing the user to update the auto-populated new government document.

181. The system of any one of claims 174 to 180, further comprising generating a confirmation notice and sending the confirmation notice to the user device indicating successful filing of the new governmental application.

182. The system of any one of claims 174 to 181, wherein the server validates the pre-stored user data against an external data source before auto-populating the new governmental application.

183. The system of any one of claims 174 to 182, further comprising encrypting the user data during retrieval, storage, and transmission to ensure data security.

184. The system of any one of claims 174 to 183, wherein the user is authenticated using multi-factor authentication when accessing the user interface to review the auto-populated new governmental application.

185. The system of any one of claims 174 to 184, further comprising generating and storing an audit trail of the steps taken to prepare and submit the new governmental application.

186. The system of any one of claims 174 to 185, wherein the user interface provides real-time feedback on the status of the governmental application after submission.

187. The system of any one of claims 174 to 186, further comprising recommending additional related services to the user based on the renewal of the government document.

188. A non-transitory computer-readable medium storing instructions that, when executed by one or more processors, cause a computer system to perform a method for providing automated replacement of a government document, the method comprising the following steps in order:
storing, in a database, user profile data and a governmental application previously completed by a user for an original government document at a government agency;
receiving, from the user via a user device, a request for a replacement of the original government document;
generating a new government document application using user profile data and the previously completed governmental application; and
submitting the generated new government document application to the government agency for processing.

189. The medium of claim 188, wherein the original government document has been lost, stolen, or damaged.

190. The medium of any one of claims 188 to 189, further comprising providing an option for the user to request the replacement of the original government document from an account of the user.

191. The medium of claim 190, wherein the replacement request is done with a single click.

192. The medium of claim 191, wherein the single click comprises an autogenerated reason for replacing the original document.

193. The medium of any one of claims 188 to 192, wherein the database is a post-release structured query language database.

194. The medium of any one of claims 188 to 193, wherein the notifying step comprises allowing the user to update the auto-populated new government document.

195. The medium of any one of claims 188 to 194, further comprising generating a confirmation notice and sending the confirmation notice to the user device indicating successful filing of the new governmental application.

196. The medium of any one of claims 188 to 195, wherein the server validates the pre-stored user data against an external data source before auto-populating the new governmental application.

197. The medium of any one of claims 188 to 196, further comprising encrypting the user data during retrieval, storage, and transmission to ensure data security.

198. The medium of any one of claims 188 to 197, wherein the user is authenticated using multi-factor authentication when accessing the user interface to review the auto-populated new governmental application.

199. The medium of any one of claims 188 to 198, further comprising generating and storing an audit trail of the steps taken to prepare and submit the new governmental application.

200. The medium of any one of claims 188 to 199, wherein the user interface provides real-time feedback on the status of the governmental application after submission.

201. The medium of any one of claims 188 to 200, further comprising recommending additional related services to the user based on the renewal of the government document.

202. The method of claim 1, further comprising automatically renewing a government document prior to its expiration date, the method comprising the following steps in order:
storing, in a database associated with a server, an expiration date of a government document from a government agency;
calculating a filing date set to a time period before the expiration date;
automatically retrieving previously stored user data relevant to the government document from the database;
automatically populating a new governmental application for the government document with the pre-stored user data;
automatically notifying the user, via a user device, to review the auto-populated new governmental application via a user interface on the user device before the filing date; and
submitting the reviewed new governmental application to a server of the government agency by the filing date.

203. The method of claim 202, wherein the time period is six months.

204. The method of claim 202, where the time period before the expiration date is when the renewal period for the government document opens.

205. The method of any one of claims 202 to 204, wherein the time period accounts for processing time.

206. The method of any one of claims 202 to 205, wherein the user device is chosen from a smartphone, a tablet, or a computer.

207. The method of any one of claims 202 to 206, further comprising generating a reminder notification and transmitting the reminder notification to the user device before the filing date.

208. The method of any one of claims 202 to 207, wherein the notifying step comprises allowing the user to update the auto-populated new government document.

209. The method of any one of claims 202 to 208, further comprising generating a confirmation notice and sending the confirmation notice to the user device indicating successful filing of the new governmental application.

210. The method of any one of claims 202 to 209, wherein the database is a post-release structured query language database.

211. The method of any one of claims 202 to 210, wherein the server validates the pre-stored user data against an external data source before auto-populating the new governmental application.

212. The method of any one of claims 202 to 211, further comprising encrypting the user data during retrieval, storage, and transmission to ensure data security.

213. The method of any one of claims 202 to 212, wherein the user is authenticated using multi-factor authentication when accessing the user interface to review the auto-populated new governmental application.

214. The method of any one of claims 202 to 213, further comprising generating and storing an audit trail of the steps taken to prepare and submit the new governmental application.

215. The method of any one of claims 202 to 214, wherein the user interface provides real-time feedback on the status of the governmental application after submission.

216. The method of any one of claims 202 to 215, further comprising recommending additional related services to the user based on the renewal of the government document.

217. The method of any one of claims 202 to 216, wherein the notification step includes providing the user with a summary of the changes made to the pre-stored user data, if any.

218. The method of claim 1, further comprising providing automated replacement of a government document, the method comprising the following steps in order:
storing, in a database, user profile data and a governmental application previously completed by a user for an original government document at a government agency;
receiving, from the user via a user device, a request for a replacement of the original government document;
generating a new government document application using user profile data and the previously completed governmental application; and
submitting the generated new government document application to the government agency for processing.

219. The method of claim 218, wherein the original government document has been lost, stolen, or damaged.

220. The method of any one of claims 218 to 219, further comprising providing an option for the user to request the replacement of the original government document from an account of the user.

221. The method of claim 220, wherein the replacement request is done with a single click.

222. The method of claim 221, wherein the single click comprises an autogenerated reason for replacing the original document.

223. The method of any one of claims 218 to 222, wherein the database is a post-release structured query language database.

224. The method of any one of claims 218 to 223, wherein the notifying step comprises allowing the user to update the auto-populated new government document.

225. The method of any one of claims 218 to 224, further comprising generating a confirmation notice and sending the confirmation notice to the user device indicating successful filing of the new governmental application.

226. The method of any one of claims 218 to 225, wherein the server validates the pre-stored user data against an external data source before auto-populating the new governmental application.

227. The method of any one of claims 218 to 226, further comprising encrypting the user data during retrieval, storage, and transmission to ensure data security.

228. The method of any one of claims 218 to 227, wherein the user is authenticated using multi-factor authentication when accessing the user interface to review the auto-populated new governmental application.

229. The method of any one of claims 218 to 228, further comprising generating and storing an audit trail of the steps taken to prepare and submit the new governmental application.

230. The method of any one of claims 218 to 229, wherein the user interface provides real-time feedback on the status of the governmental application after submission.

231. The method of any one of claims 218 to 230, further comprising recommending additional related services to the user based on the renewal of the government document.
